(19) United States
(12) Patent Application Publication
(10) Pub. No.: US 2002/0188503 A1
(43) Pub. Date: Dec. 12, 2002

(54) Providing bundled incentives to a buyer via a communications network

(75) Inventors: Dwip N. Banerjee, Austin, TX (US); Rabindranath Dutta, Austin, TX (US)

Correspondence Address: Paul D. Heydon, Patent Attorney, Suite B2, 6102 Broadway, San Antonio, TX, 78209, US

(73) Assignee: International Business Machines Corporation, Armonk, NY (US)

(21) Appl. No.: 09/876,067

(22) Filed: Jun. 7, 2001

(51) Int. Cl. G06F 17/60

(52) U.S. Cl. 705/14

(57) ABSTRACT

The present invention is a method and system for facilitating a transaction among a buyer and two or more sellers. The invention uses a computer system and a communications network such as the Internet. Typically the transaction will involve the sale of a bundle of items, including goods or services (or both), and a combination of e-coupons or other incentives such as price discounts. The invention involves defining a bundle of items, identifying a buyer, communicating to the buyer information about the bundle, tracking the buyer's purchases of items in the bundle, and providing combined incentives to the buyer for purchasing items in the bundle. A buyer may request a predefined bundle, or a customized bundle. One aspect of the present invention is a method for providing bundled incentives to a buyer via a communications network. Another aspect of the present invention is a system for executing the method of the present invention. A third aspect of the present invention is as a set of instructions on a computer-usable medium, or resident in a computer system, for executing the method of the present invention.

### FIELD OF THE INVENTION

The present invention relates generally to computer-assisted sales of goods and services, and more particularly to methods and systems using a communications network in providing bundled incentives to a buyer.

### BACKGROUND OF THE INVENTION

Electronic commerce methods in use today include the use of promotions or incentives such as price discounts. Such promotions or incentives may be electronically communicated to prospective buyers in the form of virtual, paperless coupons (e-coupons). At any time, in any given category of goods or services, there may be many promotions or incentives offered by competing manufacturers or retailers. Sellers expend money, time and effort in trying to communicate these promotions to the right prospective buyers, and thus attain the objective of increased sales. Buyers expend time and effort in discovering these promotions, to find an item for sale at the lowest price. A buyer's expenditure of time and effort is multiplied when a combination of items needs to be purchased at the same time.

Thus there is a need for systems and methods that make promotions more effective for sellers and buyers, using buyer input, combined sales, and combined incentives for buyers.

### SUMMARY OF THE INVENTION

The present invention is a computerized method and system for facilitating a transaction involving a buyer, two or more sellers, and combined incentives for the buyer. It takes advantage of the speed and information-gathering capabilities of a communications network such as the Internet. Typically the transaction will involve the sale of a bundle of items, including goods or services (or both), and a combination of e-coupons or other incentives such as price discounts. The invention involves defining a bundle of items, identifying a buyer, communicating to the buyer information about the bundle, tracking the buyer's purchases of items in the bundle, and providing combined incentives to the buyer for purchasing items in the bundle.

The following are some examples of the advantages and applications of the invention. The items in the bundle are things that a buyer may want to purchase together, (e.g. computer hardware and software, office equipment, sports equipment, home appliances, home or office furnishings, motor vehicles and accessories, and services contracts for all of the above) plus combined incentives for the buyer. An extra rebate may be offered by the operator of a bundling web site. Such an extra rebate may be financed by paid subscriptions or sellers' promotional spending. Thus incentives for the buyer are not limited to those offered by a seller.

Advantages for buyers include dealing with more than one seller at a time, and thus enjoying the benefits of economic competition. The buyer may obtain a favorable price for goods and services bought in combination, with combined incentives, especially if an extra rebate is offered by the operator of a bundling web site. In one bundle, a buyer can obtain everything that he or she needs for the best use and enjoyment of products and services, resulting in increased customer satisfaction.

Besides increased customer satisfaction, advantages for sellers include increasing the impact of promotional spending, and increased sales. The invention will let sellers take advantage of buyers' input as to what combinations of products and services the buyers want to purchase.

Advantages for web-site operators and providers of information services include a valuable service to offer customers, and a source of revenues in the form of paid subscriptions and sellers' promotional spending.

For example, the invention may involve a provider of information services receiving, via a server computer and communications network, a request from a buyer regarding a bundle of items that includes incentives. The provider may then transmit to the buyer information about a predefined bundle of items similar to what was requested by the buyer. The invention may involve a provider of information services receiving a request from a buyer regarding a bundle of items, contacting sellers to try to satisfy the request, defining a new bundle to match the request, and then transmitting to the buyer information about the new bundle. The invention may involve a provider of information services tracking the buyer's purchases of items in the bundle, and providing a rebate to the buyer, if the buyer makes certain required purchases.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of a computer system capable of performing the present invention.

FIG. 2 is a high-level block diagram illustrating an example of a system for providing bundled incentives to a buyer via a communications network, according to the teachings of the present invention.

FIG. 3 is a block diagram illustrating examples of features that may be included in a method and system for providing bundled incentives to a buyer via a communications network, according to the teachings of the present invention.

FIG. 4 is a flow chart illustrating an exemplary process for providing bundled incentives to a buyer, according to the teachings of the present invention.

FIG. 5 is a flow chart illustrating an exemplary process for handling requests from buyers seeking bundled incentives, according to the teachings of the present invention.

FIG. 6 is a diagram illustrating two examples of web pages that could be used in a method or system according to the teachings of the present invention.

### DETAILED DESCRIPTION

The examples that follow involve the use of computers and a network. The present invention is not limited as to the type of computer on which it runs, and not limited as to the type of network used. To simplify matters, the diagrams and examples that follow generally involve from two to four server computers and one network. However, more servers and more than one network may be used.

The examples that follow involve networked systems using a client/server architecture. A “client” is a member of a class or group that uses the services of another class or group to which it is not related. In the context of a computer network, such as the Internet, a client is a process (i.e., roughly a program or task) that requests a service which is provided by another program. The client process uses the requested service without having to “know” any working details about the other program or the service itself. In networked systems, a client is usually a computer that accesses shared network resources provided by another computer (i.e., a server). A “server” is typically a remote computer system which is accessible over a communications medium such as the Internet. The server scans and searches for information sources. Based upon such requests by the user, the server presents filtered electronic information to the user as server responses to the client process. The client process may be active in a second computer system, and communicate with one another over a communications medium that allows multiple clients to take advantage of the information-gathering capabilities of the server. Clients and servers may, for example, communicate with one another using the functionality provided by a Hyper Text Transfer Protocol (HTTP). The World Wide Web (WWW) or, simply, the “web,” includes all servers adhering to this protocol, which are accessible to clients via a Universal Resource Location (URL). Internet services can be accessed by specifying Universal Resource Locators that have two basic components: a protocol to be used and an object pathname. For example, the Universal Resource Locator address, “http://www.uspto.gov” (i.e., the “home page” for the U.S. Patent and Trademark Office), specifies a hypertext transfer protocol (“http”) and a pathname of the server (“www.uspto.gov”). The server name is associated with a unique numeric value (TCP/IP address). Active within the client is a first process, known as a “browser”, that establishes the connection with the server, and presents information to the user. The server itself executes corresponding server software that presents information to the client in the form of HTTP responses. The HTTP responses correspond to “web pages” constructed from a Hypertext Markup Language (HTML), or other server-generated data. A “web page” (also referred to by some designers simply as a “page”) is a data file written in a hyper-text language that may have text, graphic images, and even multimedia objects such as sound recordings or move video clips associated with that data file. The web page can be displayed as a viewable object within a computer system. A viewable object can contain one or more components such as spreadsheets, text, hotlinks, pictures, sound, and video objects. A web page can be constructed by loading one or more separate files into an active directory or file structure that is then displayed as a viewable object within a graphical user interface. When a client workstation sends a request to a server for a web page, the server first transmits (at least partially) the main hypertext file associated with the web page, and then loads, either sequentially or simultaneously, the other files associated with the web page. A given file may be transmitted as several separate pieces via TCP/IP protocol. The constructed web page is then displayed as a viewable object on the workstation monitor. A web page may be “larger” than the physical size of the monitor screen, and devices such as graphical user interface scroll bars can be utilized by the viewing software (i.e., the browser) to view different portions of the web page. Most text displayed by a web browser is formatted using standard HTML. An HTML file is a text file that contains both the text to be displayed and markup tags that describe how the text should be formatted by the web browser. The HTML markup tags support basic text formatting, such as paragraph breaks, bullet lists, tables, graphs, charts, and so forth. In addition to these basic text formatting tags, HTML provides tags defining graphical user interface components. HTML also can be used to display well known graphical user interface components such as radio buttons, check boxes, scrolling lists of selectable text, and various other such components at the web browser itself. In an open network, such as the Internet, establishing a secure connection is required in order to prevent a third party from viewing sensitive information, such as personal data or financial transactions. Secure connections can be established between a browser running on a typical client machine, or on a network computer, and a web server using a security protocol such as Secure Sockets Layer (SSL).

Various implementation methods may be used for the present invention. The examples that follow involve information that is communicated between computers; this information could be in hypertext markup language (HTML), or extensible markup language (XML), or some other language or protocol could be used.

XML provides a way of containing and managing information that is designed to handle data exchange among various data systems. Thus it is well-suited to implementation of the present invention. Reference is made to the book by Elliotte Rusty Harold and W. Scott Means, XML in a Nutshell (O'Reilly & Associates, 2001). As a general rule XML messages use “attributes” to contain information about data, and “elements” to contain the actual data. Reference is made to a white paper by Transentric, a division of Union Pacific Corporation, TranXML [TM]: The Common Vocabulary for Transportation Data Exchange (2001), available at http://www.transentric.com. The paper describes TranXML [TM], an example of a markup language developed for data exchange in the transportation industry. The data format is readable by both humans and machines. These XML structures are open source software, freely available under a General Public License, and they include XML structures for messages relating to tracing shipped goods (e.g. a Shipment Status Message).

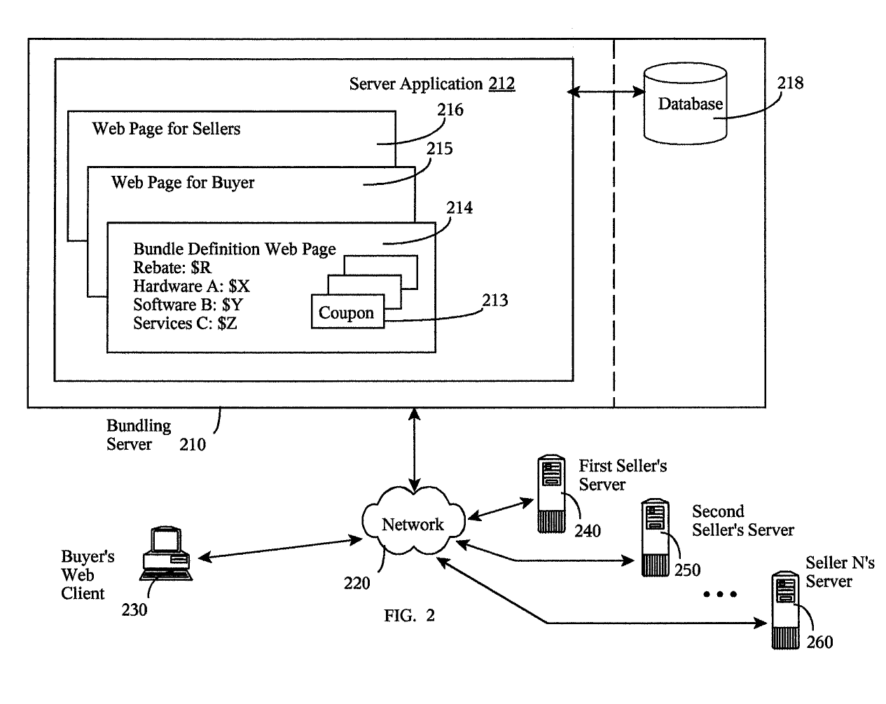

The invention involves transmitting to buyers information that is dynamically adjusted. One way of implementing this is by using dynamic web pages. The dynamic web pages would merge constantly-updated descriptions of bundles, stored in a database, with a web-page template, on the fly. Reference is made to the article by Larry Roth, “Working Wonders on the Web: Building a Dynamic Website Using Apache, MYSQL, and PHP,” Linux Magazine, Vol. 2, No. 8, August 2000, pages 64-72. The dynamic web pages could be implemented by using three software components: a web server, a database, and a scripting language such as PHP. For the web server, one might use Apache Server, available as free, open-source software from the Apache Software Foundation, or one might use other similar software of the kind available from IBM or Microsoft, for example. For the database, one might use DB2, available from IBM, MySQL, available as free, open-source software, or other similar software of the kind available from Oracle or Microsoft, for example. For the scripting language, one might use a programming language such as PHP, Perl, or another similar language. Using HTML, a bundle definition web page like the one described in connection with FIG. 2, would be created, with an area where dynamic bundle descriptions may be inserted. Embedded in the page would be code, written in the scripting language, to query and retrieve data from the database. When the bundle definition web page is called by the web server, the web server would process the code and replace it with dynamic bundle descriptions from the database.

The following are definitions of terms used in the description of the present invention and in the claims:

“Bundle of items” means any group or combination of things, from more than one seller or source, including goods, services, software, coupons, incentives, or rebates.

“Buyer” means any person or organization who buys goods or services.

“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.

“E-coupon” means any paperless coupon, such as a paperless coupon allowing a rebate, a reduced price, or allowing someone to receive goods or services free of charge.

“Maintaining” a database means storing data in a database, regardless of how current the data is.

“Seller” means any person or organization who sells goods, or services, including a manufacturer, wholesaler, service provider, or retailer.

“Storing” data or information, using a computer, means placing the data or information, for any length of time, in any kind of computer memory, such as floppy disks, hard disks, Random Access Memory (RAM), Read Only Memory (ROM), CD-ROM, flash ROM, non-volatile ROM, and non-volatile memory.

“Updating” means bringing up to date, by any process, automatic or otherwise.

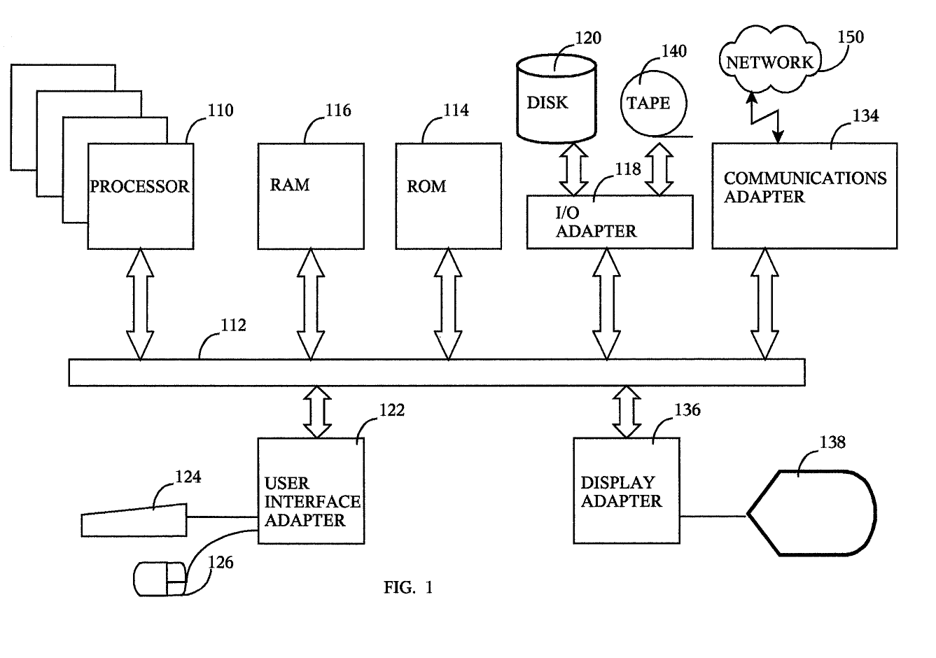

FIG. 1 illustrates a simplified example of an information handling system that may be used to practice the present invention. The invention may be implemented on a variety of hardware platforms, including personal computers, workstations, servers, and embedded systems. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112, user interface adapter 122 for connecting keyboard 124, mouse 126 or other user interface devices to bus 112, communication adapter 134 for connecting the information handling system to a data processing network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as Intranets) and wide area networks, such as the Internet.

While the computer system described in FIG. 1 is capable of executing the processes described herein, this computer system is simply one example of a computer system. Those skilled in the art will appreciate that many other computer system designs are capable of performing the processes described herein.

FIG. 2 is a high-level block diagram illustrating an example of a system for providing bundled incentives to a buyer via a communications network, according to the teachings of the present invention. In this example, buyer's web client 230, a bundling web server 210, and sellers' web servers 240, 250, and 260 are coupled through a network 220. Buyer's web client 230, bundling web server 210, and sellers' web servers 240, 250, and 260 may be implemented as conventional computer systems. Alternatively, the buyer's web client 230 can be implemented as a network computer or thin client device. Buyer's web client 230 may also be a laptop computer, a hand-held computing device, a personal digital assistant (PDA), or a mobile telephone. Buyer's web client 230 may use a wireless communications network, and may use Wireless Application Protocol (WAP), for example. Software application programs for implementing the present invention run on Buyer's web client 230, bundling web server 210, and sellers' web servers 240, 250, and 260. The server portion of the application software of the present invention is shown as server application 212. In addition, bundling web server 210 includes or has access to a database (or information store) 218 for storing and managing information. For example, database 218 represents a way to maintain a database containing data associated with a bundle of items. As indicated by the dashed line in bundling web server 210, database 218 may be incorporated into bundling web server 210 or may be operated as a database system independent of, but accessible to, bundling web server 210. Software application programs running on buyer's web client 230 may include a graphical user interface, a browser and purchasing software.

Bundling web server 210 may include various web pages, some of which are shown as bundle definition web page 214, web page for buyer 215, and web page for sellers 216. Bundle definition web page 214 is an example of one way to communicate, from bundling web server 210 to buyer's web client 230, the definition of a bundle. Bundle definition web page 214 shows a rebate of R, Hardware A, with a price of $X, Software B with a price of $Y, and Services C, with a price of $Z. Bundle definition web page 214 shows one or more coupons, at 213; defining a bundle of items may include defining a bundle of e-coupons. An e-coupon may provide an incentive or sales promotion associated with an item of goods or services, or an e-coupon may provide an incentive or sales promotion associated with the bundle as a whole. Web page for buyer 215 is an example of one way to receive, via bundling server 210 and network 220, a request from buyer's web client 230; i.e. web page for buyer 215 would receive input from a buyer requesting a bundle. A buyer may request a predefined bundle, or a customized bundle. Web page for sellers 216 is an example of one way for bundling server 210 to communicate and interact with sellers, via network 220. For example, bundling server 210 may receive data, regarding earlier transactions, from sellers, store the data in database 218, and update the data continuously. Web page for sellers 216 is an example of one way for bundling server 210 to receive data from sellers, via network 220, to define a bundle of items. Web page for sellers 216 is an example of one way for bundling server 210 to contact one or more sellers, via network 220, to try to satisfy a request from a buyer. Web page for sellers 216 is an example of one way for sellers to display information about bundles that include coupons or other incentives offered by a certain seller.

On the other hand, bundling web server 210 may communicate via network 220 with sellers' web servers 240, 250, and 260, without using a web page. Bundling web server 210 may receive, via network 220, information about a buyer's purchases, from sellers' web servers 240, 250, and 260. Bundling server 210 thus may be used to track a buyer's purchases.

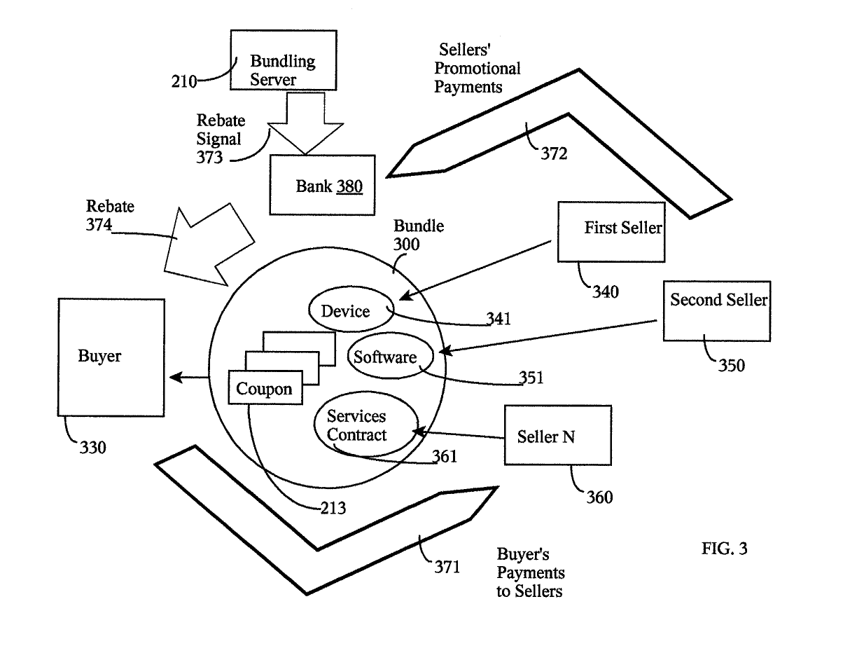

FIG. 3 is a block diagram illustrating examples of features that may be included in a method and system for providing bundled incentives to a buyer via a communications network, according to the teachings of the present invention. At the center of the diagram is bundle 300, an example of a bundle of items containing device 341 sold by first seller 340, software 351 sold by second seller 350, services contract 361 sold by seller N, at 360, and one or more coupons, at 213. Bundling server 210 would be used to define bundle 300, i.e. to determine which goods, services and e-coupons should be bundled together. Bundling server 210 would be used to communicate to buyers such as buyer 330 the definition of bundle 300. Bundle 300 is being purchased by buyer 330, who makes payments, 371, to first seller 340, second seller 350, and seller N, at 360. Sellers such as first seller 340, second seller 350, and seller N, at 360, make sellers' promotional payments, 372, to bank 380, to finance the incentives or sales promotions represented by one or more coupons, at 213. These are incentives provided to buyers for purchasing items in bundle 300. Possible incentives include providing a rebate to a buyer, allowing a buyer to make a purchase at a reduce price, allowing a buyer to receive goods or services free of charge, or providing a bundle of e-coupons to a buyer. Bundle 300 may be defined such that certain required purchases, and a rebate, are associated with bundle 300. Bundling server 210 may be used to track a buyer's purchases. For example, an XML message may be transmitted via a network from a seller's server to bundling server 210. The XML message may contain data including an identifier for the seller, an identifier for the buyer, an identifier for the item sold, bundle and discount information, and a confirmation of the sale. If buyer 330 makes the required purchases, bundling server 210 transmits a rebate signal 373 to bank 380 to provide a rebate 374 to buyer 330. This figure shows one example of providing combined incentives to a buyer Other ways of providing combined incentives to a buyer might not involve a bank.

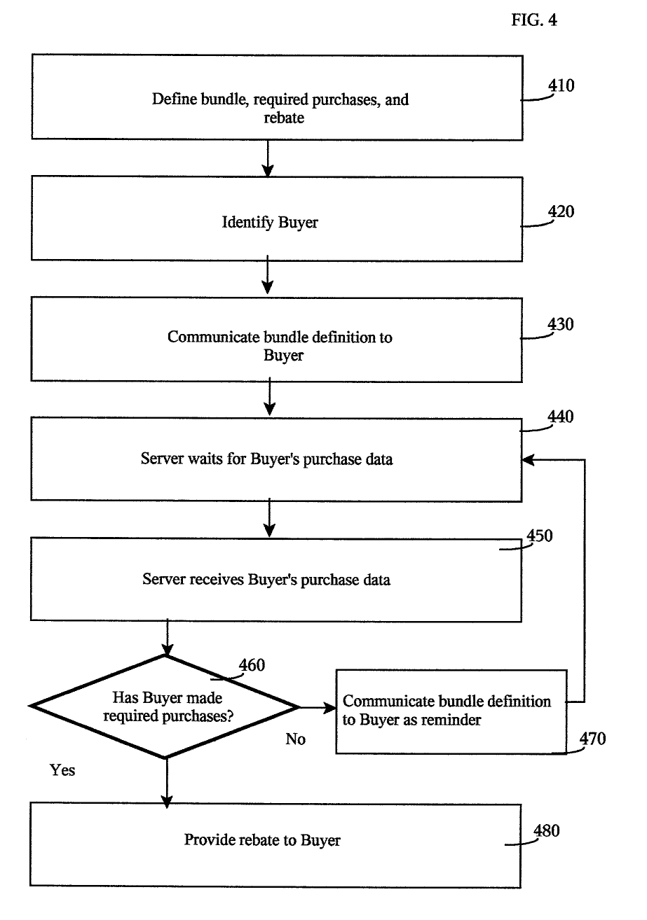

FIG. 4 is a flow chart illustrating an exemplary process for providing bundled incentives to a buyer, according to the teachings of the present invention. The process begins at block 410 with defining a bundle of items. A bundle may be defined such that certain required purchases, and a rebate, are associated with the bundle. The process continues at block 420 with identifying a buyer. For example, identifying a buyer may involve a bundling server receiving a request from a buyer who is interested in buying a bundle of items that has incentives associated with it.

The response to a request from a buyer, and the definition of a bundle, may be dynamically adjusted, based on factors such as the sellers' inventory levels, the sellers' budget for promotional spending, the buyer's previous transactions, and whether the buyer is a first-time customer.

The definition of a bundle is communicated to the buyer at block 430. Then the buyer may communicate with sellers to buy items in the bundle. The buyer may communicate with sellers directly, or may use the bundling web site as an intermediary. In making the purchases, the buyer may visit a seller in person, or conclude the purchase via a telephone conversation with a seller, or communicate via the buyer's web client with a seller's web server. At this point, the buyer may take advantage of any incentives associated with the purchase of specific items. A bundling server may be used to track a buyer's purchases, as described above regarding FIG. 3. The bundling server waits for data regarding a buyer's purchases at block 440. The bundling server receives data regarding a buyer's purchases at block 450. If the buyer has made all the required purchases associated with the bundle, the “Yes” branch is taken at decision 460 and a rebate is provided to the buyer at block 480. An extra rebate may be offered by the operator of a bundling web site. Such an extra rebate may be financed by paid subscriptions or sellers' promotional spending. On the other hand, if the buyer has not made all the required purchases associated with the bundle, the “No” branch is taken at decision 460. Next, at block 470 the bundling server may communicate a message to the buyer, such as an acknowledgment of the latest purchase and a reminder of the required purchases associated with the bundle, before returning to block 440, where the bundling server waits for data regarding a buyer's purchases.

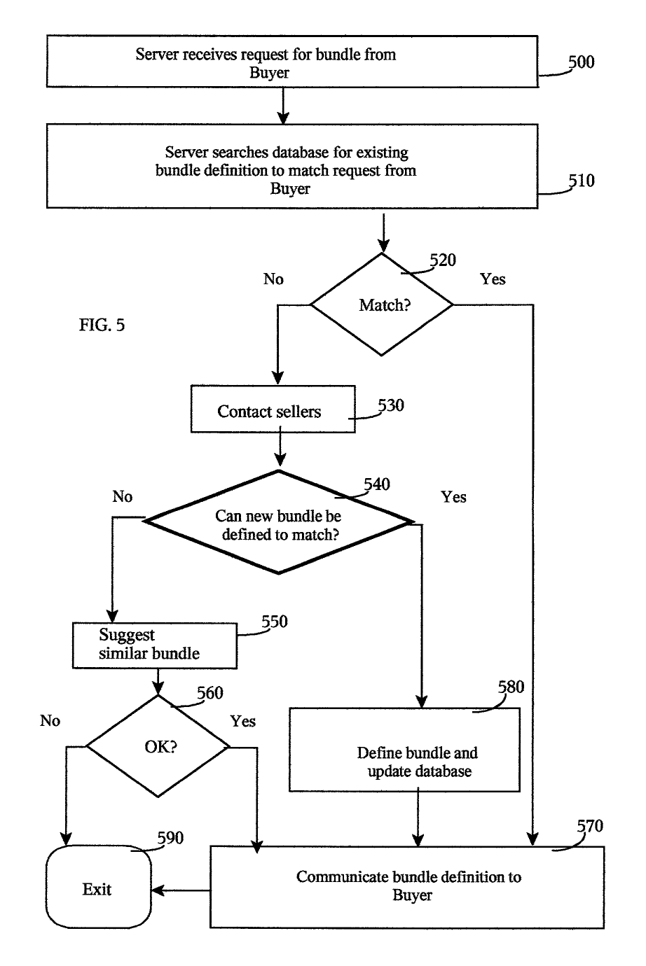

FIG. 5 is a flow chart illustrating an exemplary process for handling requests from buyers seeking bundled incentives, according to the teachings of the present invention. The process begins at block 500, with the bundling server receiving, via a communications network, a request from a buyer seeking bundled incentives. The buyer may request a bundle containing specific items that the buyer is planning to buy. Next, at block 510, the bundling server searches a database of previously-defined bundles, for a bundle with a definition to match the request from the buyer. If a matching bundle is found in the database, at decision 520 the “Yes” branch is taken; next, at block 570, the bundling server communicates the matching bundle definition to the buyer, and then exits at block 590.

On the other hand, if a matching bundle is not found in the database, at decision 520 the “No” branch is taken; next, at block 530, sellers are contacted; i.e. inquiry is made of at least one seller, in an effort to satisfy the buyer's request.

This part of the process could be done in various ways. It could be automated, with the bundling server transmitting a message over a network to one or more sellers' servers, and receiving responses from sellers' servers, while the buyer waited for the result. An expert system or software agent might be provided to define a new bundle to match the buyer's request, based on responses from sellers' servers. As an alternative, if at decision 520 the “No” branch is taken, human intervention could be called for. A promotions manager could then interact online with the buyer, via an instant-messaging feature, or “chat” mode, for example. The promotions manager could gather more information from the buyer, explain what steps would be taken to satisfy the buyer's request, and tell the buyer how long the process might take. Then the promotions manager could make an effort to satisfy the buyer's request, contacting one or more sellers, by e-mail, telephone, fax messages or other means. Based on responses from sellers, and the promotions manager's business judgment, a new bundle might be defined to match the buyer's request. The promotions manager might, for example, try to predict whether other buyers would want a bundle of the kind requested. The promotions manager might negotiate with various sellers concerning the type of goods and services, and the magnitude of the discounts, to be included in a new bundle.

Whether automated or not, the sub-process of contacting sellers at block 530 is followed by decision 540; if the responses from sellers allow the definition of a new bundle to match the buyer's request, the “Yes” branch is taken. Then at block 580 the new bundle is defined and the database of previously-defined bundles is updated. Next, at block 570, the bundling server communicates the new matching bundle definition to the buyer, and then exits at block 590. On the other hand, if at decision 540 the responses from sellers do not allow the definition of a new bundle to match the buyer's request, the “No” branch is taken. Then at block 550 a similar bundle may be suggested to the buyer; i.e. the buyer may be given some information about a bundle of items that is somewhat similar to what the buyer requested. For example, the bundling server may transmit to the buyer a message notifying the buyer that it was not practical to define a new bundle to exactly match the buyer's request, but that the database of previously-defined bundles contains one or more bundles that are similar to the one requested. A summary of the similar bundle may be transmitted to the buyer, along with a request for input, at block 550. If, at decision 560, the buyer provides input indicating that the similar bundle might be acceptable, the “Yes” branch is taken. Next, at block 570, the bundling server communicates the similar bundle definition to the buyer, and then exits at block 590. On the other hand, if at decision 560 the buyer provides input indicating that the similar bundle is not acceptable, the “No” branch is taken, and the process ends at block 590.

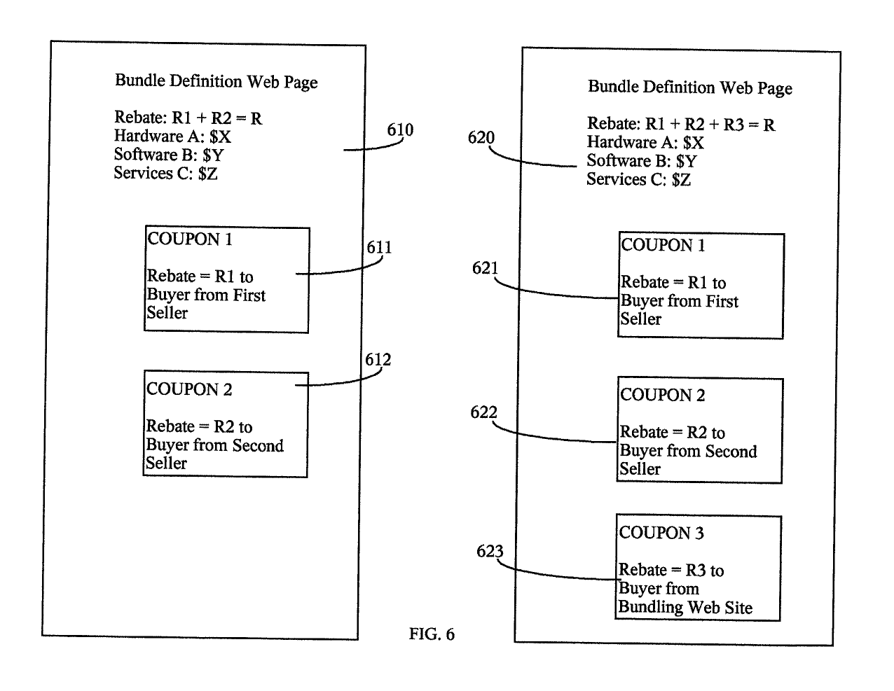

FIG. 6 is a diagram illustrating two examples of web pages that could be used in a method or system according to the teachings of the present invention. Such a web page may be used to communicate to a buyer the definition of a bundle. The Bundle Definition Web Page shown at 610 shows a total rebate of R1+R2=R. The source of Rebate R1 is Coupon 1 from First Seller, shown at 611. The source of Rebate R2 is Coupon 2 from Second Seller, shown at 612. The other items listed in the Bundle Definition Web Page shown at 610 are Hardware A, with a price of $X, Software B with a price of $Y, and Services C, with a price of $Z. The other Bundle Definition Web Page, shown at 620, shows a total rebate of R1+R2+R3=R. The source of Rebate R1 is Coupon 1 from First Seller, shown at 621. The source of Rebate R2 is Coupon 2 from Second Seller, shown at 622. The source of Rebate R3 is Coupon 3 from the Bundling Web Site, shown at 623. This means that there is an additional incentive offered to the buyer for the purchase of the bundle defined at 620, as compared with the bundle defined at 610. An extra rebate may be offered by the operator of a bundling web site. Such an extra rebate may be financed by paid subscriptions or sellers' promotional spending. The other items listed in the Bundle Definition Web Page shown at 620 are Hardware A, with a price of $X, Software B with a price of $Y, and Services C, with a price of $Z.

One of the preferred implementations of the invention is an application, namely a set of instructions (program code) in a code module which may, for example, be resident in the random access memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the required method steps.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

We claim:

1. A method for using a computer to facilitate a transaction involving a buyer and a plurality of sellers, said method comprising:
defining a bundle of items;
identifying said buyer;
communicating to said buyer the definition of said bundle;
tracking said buyer's purchases of items in said bundle; and
providing combined incentives to said buyer for purchasing items in said bundle.

2. The method of claim 1, wherein said providing combined incentives further comprises providing a bundle of e-coupons to said buyer.

3. The method of claim 2, wherein:
said providing combined incentives is accomplished by using a single web site; and
the operator of said web site provides an incentive financed by said sellers' promotional spending.

4. The method of claim 1, wherein said defining further comprises receiving data regarding earlier transactions.

5. The method of claim 1, wherein said defining further comprises:
receiving data from said plurality of sellers; and
updating said data continuously.

6. The method of claim 1, wherein:
said identifying further includes receiving a request from said buyer; and
said defining further includes:
contacting at least one of said plurality of sellers to try to satisfy said request;
defining said bundle to match said request;
maintaining a database containing data associated with said bundle; and
updating a database with new data regarding said bundle.

7. The method of claim 1, wherein:
said identifying further includes receiving a request from said buyer; and
said communicating further includes transmitting to said buyer information about a predefined bundle similar to what was requested by said buyer.

8. The method of claim 1, wherein said providing combined incentives further comprises providing a rebate to said buyer.

9. The method of claim 1, wherein said providing combined incentives further comprises allowing said buyer to make a purchase at a reduced price.

10. The method of claim 1, wherein said providing combined incentives further comprises allowing said buyer to receive goods or services free of charge.

11. The method of claim 1, wherein:
said identifying further includes receiving a request from said buyer; and
said defining further includes defining said bundle to match said request.

12. A method for using a computer to facilitate a transaction involving a buyer and a plurality of sellers, said method comprising:
providing a server computer in communication with a communications network;
receiving data, via said server computer and said communications network, to define a bundle of items;
defining said bundle, required purchases associated with said bundle, and a rebate associated with said bundle;
maintaining a database containing data associated with said bundle;
communicating to said buyer, via said server computer and said communications network, the definition of said bundle;
receiving, via said server computer and said communications network, information about said buyer's purchases; and
transmitting, via said server computer and said communications network, a signal to provide said rebate to said buyer, if said buyer makes said required purchases.

13. The method of claim 12, wherein said defining further comprises defining a bundle of e-coupons.

14. The method of claim 12, wherein said defining further comprises:
receiving, via said computer and said communications network, a request from said buyer; and
transmitting to said buyer, via said computer and said communications network, information about a predefined bundle similar to what was requested by said buyer.

15. The method of claim 12, wherein said defining further comprises:
receiving, via said computer and said communications network, a request from said buyer;
contacting at least one of said plurality of sellers to try to satisfy said request;
defining said bundle to match said request; and
updating said database with new data regarding said bundle.

16. A system for facilitating a transaction involving a buyer and a plurality of sellers, said system comprising:
a server computer in communication with a communications network;
means for receiving data, via said server computer and said communications network, to define a bundle of items;
means for defining said bundle, required purchases associated with said bundle, and a rebate associated with said bundle;
means for maintaining a database containing data associated with said bundle;
means for communicating to said buyer, via said server computer and said communications network, the definition of said bundle;
means for receiving, via said server computer and said communications network, information about said buyer's purchases; and
means for transmitting, via said server computer and said communications network, a signal to provide said rebate to said buyer, if said buyer makes said required purchases.

17. The system of claim 16, wherein said means for defining further comprises means for defining a bundle of e-coupons.

18. The system of claim 16, wherein said means for defining further comprises:
means for receiving, via said computer and said communications network, a request from said buyer; and
means for transmitting to said buyer, via said computer and said communications network, information about a predefined bundle similar to what was requested by said buyer.

19. The system of claim 16, wherein said means for defining further comprises:
means for receiving, via said computer and said communications network, a request from said buyer;
means for contacting at least one of said plurality of sellers to try to satisfy said request;
means for defining said bundle to match said request; and
means for updating said database with new data regarding said bundle.

20. A computer-usable medium, having computer-executable instructions for facilitating a transaction involving a buyer and a plurality of sellers, using a server computer in communication with a communications network, said computer-executable instructions comprising:
means for receiving data, via said server computer and said communications network, to define a bundle of items;
means for defining said bundle, required purchases associated with said bundle, and a rebate associated with said bundle;
means for maintaining a database containing data associated with said bundle;
means for communicating to said buyer, via said server computer and said communications network, the definition of said bundle;
means for receiving, via said server computer and said communications network, information about said buyer's purchases; and
means for transmitting, via said server computer and said communications network, a signal to provide said rebate to said buyer, if said buyer makes said required purchases.

21. The computer-usable medium of claim 20, wherein said means for defining further comprises means for defining a bundle of e-coupons.

22. The computer-usable medium of claim 20, wherein said means for defining further comprises:
means for receiving, via said computer and said communications network, a request from said buyer; and
means for transmitting to said buyer, via said computer and said communications network, information about a predefined bundle similar to what was requested by said buyer.

23. The computer-usable medium of claim 20, wherein said means for defining further comprises:
means for receiving, via said computer and said communications network, a request from said buyer;
means for contacting at least one of said plurality of sellers to try to satisfy said request;
means for defining said bundle to match said request; and
means for updating said database with new data regarding said bundle.
